(19) United States
(12) Patent Application Publication
(10) Pub. No.: US 2021/0035167 A1
(43) Pub. Date: Feb. 4, 2021

(54) SYSTEM AND METHOD FOR RECOMMENDING DIGITAL ADVERTISEMENTS AND PUBLISHERS

(71) Applicant: Huawei Technologies Co., Ltd., Shenzhen (CN)

(72) Inventors: Xun Hu, Santa Clara, CA (US); Xin Yu, Santa Clara, CA (US)

(21) Appl. No.: 17/074,366

(22) Filed: Oct. 19, 2020

Related U.S. Application Data
(63) Continuation of application No. PCT/CN2019/084752, filed on Apr. 28, 2019.
(60) Provisional application No. 62/730,404, filed on Sep. 12, 2018.

(51) Int. Cl. G06Q 30/02

(52) U.S. Cl. CPC G06Q 30/0277; G06Q 30/0275; G06Q 30/0276; G06Q 30/0256

(57) ABSTRACT

According to one aspect of the present disclosure, there is provided a method, by an advertiser directory service, that includes: receiving search criteria comprising one or more searching keywords, a performance threshold, and media information; identifying a category node in a tree structure according to the searching keywords and the performance threshold, the category node comprising a plurality of advertiser nodes; selecting a subset of the advertiser nodes according to the media information and the performance threshold; and recommending a publisher bid on the subset of the advertiser nodes.

### CROSS-REFERENCE TO RELATED APPLICATIONS

This application is a continuation of International Application No. PCT/CN2019/084752, filed on Apr. 28, 2019 which claims the benefit of U.S. Provisional Application No. 62/730,404 filed Sep. 12, 2018, all of which are incorporated by reference in its entirety.

### TECHNICAL FIELD

The present invention relates generally to a system and method for digital advertising, and, in particular embodiments, to a system and method for recommending digital advertisements and publishers.

### BACKGROUND

Advertising is often used to support media platforms. In particular, media platforms such as websites, blogs, search engines, applications, streaming services, and the like may derive revenue from online advertising. In online advertising systems, there are several components or sub-systems that work together to provide advertisements to a media platform. One way of providing advertisements is selling advertisement slots on a media platform. Advertisers bid on one or more advertisement slots, and the winning advertiser provides their advertisement to the media platform for display using the slot. For example, an advertisement slot for a media platform may be published to an advertising exchange (ADX) by supply-side media platforms (SSPs) of the ADX, and advertisers may browse and bid on desired advertisement slots through demand-side platforms (DSPs) of the ADX.

### SUMMARY

According to one aspect of the present disclosure, there is provided a method, by an advertiser directory service, that includes: receiving search criteria comprising one or more searching keywords, a performance threshold, and media information; identifying a category node in a tree structure according to the searching keywords and the performance threshold, the category node comprising a plurality of advertiser nodes; selecting a subset of the advertiser nodes according to the media information and the performance threshold; and recommending a publisher bid on the subset of the advertiser nodes.

Optionally, in any of the preceding aspects, a further implementation of the aspect provides that the category node comprises a plurality of sub-category nodes, and the sub-category nodes comprise the advertiser nodes. Optionally, in any of the preceding aspects, a further implementation of the aspect provides that the method further includes: selecting a subset of the sub-category nodes according to the performance threshold. Optionally, in any of the preceding aspects, a further implementation of the aspect provides that the category node comprises a performance score, and wherein identifying the category node comprises: selecting the category node in response to the performance score of the category node being greater than the performance threshold of the search criteria. Optionally, in any of the preceding aspects, another implementation of the aspect provides that the advertiser nodes comprise media information and a performance score, and wherein selecting the subset of the advertiser nodes comprises: selecting the subset of the advertiser nodes in response to the media information of the advertiser nodes matching the media information of the search criteria, and in response to the performance score of the advertiser nodes being greater than the performance threshold of the search criteria. Optionally, in any of the preceding aspects, a further implementation of the aspect provides that the method further includes: receiving advertiser feedback; and updating the performance score of each of the advertiser nodes according to the advertiser feedback. Optionally, in any of the preceding aspects, a further implementation of the aspect provides that the advertiser nodes further comprise bidding price information, and further comprising: receiving bid price feedback; and updating the bidding price information of each of the advertiser nodes according to the bid price feedback. Optionally, in any of the preceding aspects, a further implementation of the aspect provides that the searching keywords comprises a category name.

According to one aspect of the present disclosure, there is provided a method, by a publisher directory service, that includes: receiving search criteria comprising one or more searching keywords and a performance threshold; identifying a category node in a tree structure according to the searching keywords and the performance threshold, the category node comprising a plurality of publisher nodes; selecting a subset of the publisher nodes according to the performance threshold; and recommending an advertiser select an advertising slot from the subset of the publisher nodes.

Optionally, in any of the preceding aspects, another implementation of the aspect provides that the category node comprises a plurality of sub-category nodes, and the sub-category nodes comprise the publisher nodes. Optionally, in any of the preceding aspects, a further implementation of the aspect provides that the method further includes: selecting a subset of the sub-category nodes according to the performance threshold. Optionally, in any of the preceding aspects, a further implementation of the aspect provides that the category node comprises a performance score, and wherein identifying the category node comprises: selecting the category node in response to the performance score of the category node being greater than the performance threshold of the search criteria. Optionally, in any of the preceding aspects, a further implementation of the aspect provides that the publisher nodes comprise a performance score, and wherein selecting the subset of the publisher nodes comprises: selecting the subset of the publisher nodes in response to the performance score of the publisher nodes being greater than the performance threshold of the search criteria. Optionally, in any of the preceding aspects, a further implementation of the aspect provides that the method further includes: receiving publisher feedback; and updating the performance score of each of the publisher nodes according to the publisher feedback. Optionally, in any of the preceding aspects, a further implementation of the aspect provides that the searching keywords comprises a category name.

According to one aspect of the present disclosure, there is provided a device that includes: a non-transitory memory storage comprising instructions; and one or more processors in communication with the memory, where the one or more processors execute the instructions to: receive search criteria comprising one or more searching keywords, a performance threshold, and media information; identify a category node in a tree structure according to the searching keywords and the performance threshold, the category node comprising a plurality of advertiser nodes; select a subset of the advertiser nodes according to the media information and the performance threshold; and recommend a publisher bid on the subset of the advertiser nodes.

According to one aspect of the present disclosure, there is provided a device that includes: a non-transitory memory storage comprising instructions; and one or more processors in communication with the memory, where the one or more processors execute the instructions to: receive search criteria comprising one or more searching keywords and a performance threshold; identify a category node in a tree structure according to the searching keywords and the performance threshold, the category node comprising a plurality of publisher nodes; select a subset of the publisher nodes according to the performance threshold; and recommend an advertiser select an advertising slot from the subset of the publisher nodes.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a system for providing advertising and publisher recommendations, in accordance with some embodiments;

FIG. 2A is a block diagram of a tree structure for storing potential advertisers, in accordance with some embodiments;

FIG. 2B is a block diagram showing a tree structure with example data;

FIGS. 3A and 3B illustrate data structures that form a tree structure, in accordance with some embodiments;

FIGS. 4A through 4C show a block diagram of a method for recommending advertisers, in accordance with some embodiments;

FIG. 5 illustrates traversal of a tree structure, in accordance with some embodiments;

FIG. 6A is a block diagram of a tree structure for storing potential publishers, in accordance with some embodiments;

FIG. 6B is a block diagram showing a tree structure with example data;

FIGS. 7A and 7B illustrate data structures that form a tree structure, in accordance with some embodiments;

FIG. 8 illustrates traversal of a tree structure, in accordance with some embodiments;

FIGS. 9A, 9B, and 9C illustrate data structures that may be used to communicate performance feedback about advertisers and publishers, in accordance with some embodiments;

FIG. 10 shows a block diagram of a method for updating performance of advertisers, in accordance with some embodiments;

FIG. 11 shows an example of updating performance of advertisers;

FIG. 12 illustrates a publisher recommendation method 1300, in accordance with some embodiments;

FIG. 13 illustrates an advertiser recommendation method 1200, in accordance with some embodiments; and

FIG. 14 is a block diagram of a processing system, in accordance with some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

In accordance with some embodiments, a system and method for recommending digital advertisements and publishers to one another is provided. Often, a media platform, particularly one with good branding, wishes to display relevant or matching advertisements, particularly from advertisers which are trustworthy and match the media platform's branding image. For example, advertisers that provide malicious content (e.g., computer viruses, spyware, etc.) may be undesirable for media platforms. Similarly, advertiser may also wish to display their advertisements for their products on a trusted media platforming that matches the branding of the advertiser or products. In some embodiments, advertisers are categories into one or more categories, which may be searched based on criteria. The criteria may include categories, keywords, performance thresholds, and the like. Embodiments may advantageously leverage big data and cloud computing technologies to quickly intelligently and accurately recommend advertisers to media platforms and vice-versa. Latency incurred by selling and bidding on advertisement slots may also be reduced.

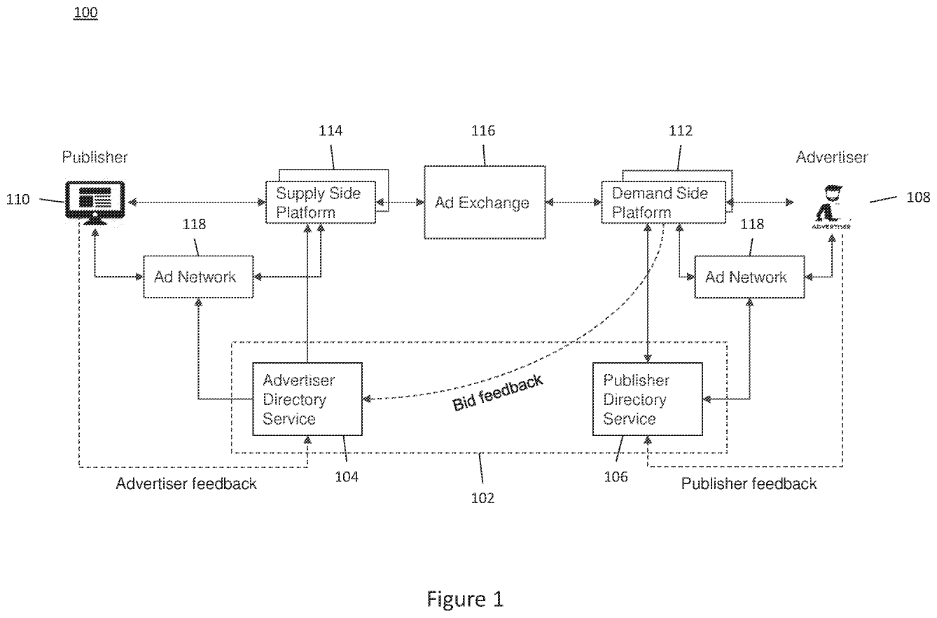

FIG. 1 is a block diagram of a system 100 for providing advertising and publisher recommendations, in accordance with some embodiments. The system 100 includes a recommendation service 102, which includes an advertiser directory service 104 and a publisher directory service 106. The recommendation service 102 may be used to recommend high quality and trusted advertisers 108 and publishers 110 to one another. The system 100 further includes a demand-side platform 112, to which advertisers 108 broadcast available advertisements, and includes a supply-side platform 114, to which publishers 110 broadcast available advertising slots. The demand-side platform 112 and supply-side platform 114 may communicate across an advertising exchange 116 to decide on an advertisement for an advertisement slot, and the advertisement may then be served from an advertisement network 118.

Potential advertisers 108 are maintained in a tree structure, which may be stored in a database or the like at the advertiser directory service 104. Similarly, potential publishers 110 are maintained in a tree structure, which may also be stored in a database or the like at the publisher directory service 106. The tree structures (discussed below) may categorize advertisers and publishers. The recommendation service 102 is used to search the advertiser directory service 104 or publisher directory service 106, with potential search criteria (sometimes referred to as input criteria) being specified by an advertiser 108 (or publisher 110), including categories, keywords, performance thresholds, and the like.

The advertiser directory service 104 may recommend matched and trusted advertisers 108 to publishers 110 based on advertisement slot information from the publishers 110, such as the publisher category and keywords. Recommendations may also be pruned based on a black list of advertisers from the publishers 110. The advertiser directory service 104 may dynamically update the performance metrics of advertisers 108 based on feedback from the publishers 110.

The publisher directory service 106 may recommend matched publishers 110 to advertisers 108 based on advertisement information from the advertisers 108, such as the advertisement category and keywords. Recommendations may also be pruned based on performance of the publishers 110. The publisher directory service 106 may dynamically update the performance metrics of publishers 110 based on feedback from the advertisers 108.

The recommendation service 102 and advertising network 118 may be co-located in a same network or service provider, or may be separate services located with separate providers. In some embodiments, the recommendation service 102 is a separate service hosted in a cloud computing datacenter, and exposes interfaces to the other components of the system 100 for interacting with the recommendation service 102. As such, the recommendation service 102 may be cross-platform, and may be accessed by multiple platforms including the demand-side platform 112, supply-side platform 114, advertising exchange 116, and advertising network 118. In some embodiments, the interfaces to the recommendation service 102 are exposed via web interfaces, such as representational state transfer (REST) interfaces.

In some embodiments, advertisers 108 are recommended to publishers 110 based on the search criteria by comparing the search criteria to information associated with each category of advertisers. When a category matches the input searching criteria, subcategories of that category may also be compared until the closest matching categories and advertisers 108 are determined. The recommended advertisers 108 are then returned back to the requesting publisher 110. The publisher 110 may then select one or more of the recommend advertisers 108 according to any criteria, and bid on those advertisers 108 using, e.g., the demand-side platform 112. The advertisements may then be delivered to the publisher 110 via the advertising network 118.

In some embodiments, publishers 110 are recommended to advertisers 108 based on the search criteria. A similar searching process may be performed as outlined above for recommending advertisers 108 to publishers 110. The advertisers 108 may then select one or more of the recommend publishers 110 according to any criteria, and indicate those publishers 110 using, e.g., the supply-side platform 114.

In some embodiments, performance for each set of advertisers 108 and publishers 110 is dynamically updated based on feedbacks. There may be several types of feedbacks. In some embodiments, the publishers 110 may provide advertiser performance feedback. In some embodiments, the advertisers 108 may provide publisher performance feedback. In some embodiments, the demand-side platform 112 may provide bidding price feedback. The feedback may be received periodically from each of the parties. Performance scores for the advertisers 108 and publishers 110 are calculated based on the received feedback. Performance scores of sub-categories and individual advertisers 108 and publishers 110 may be updated in the aggregate when feedback is provided for a category.

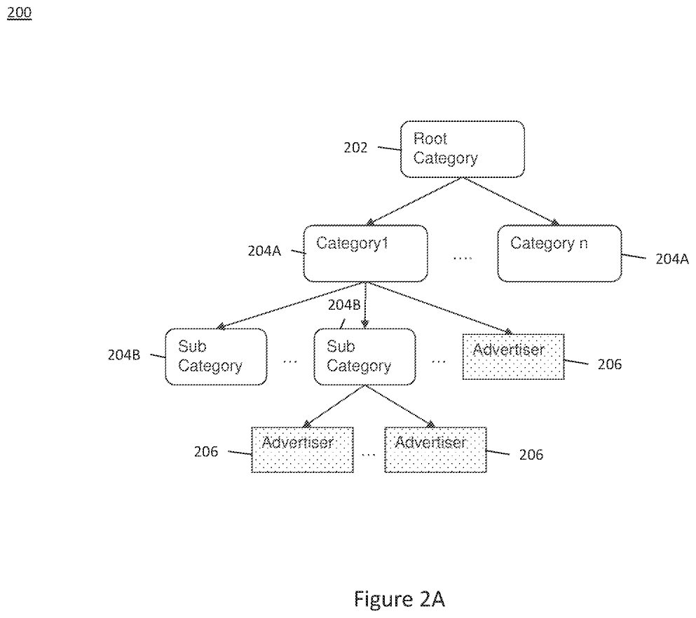

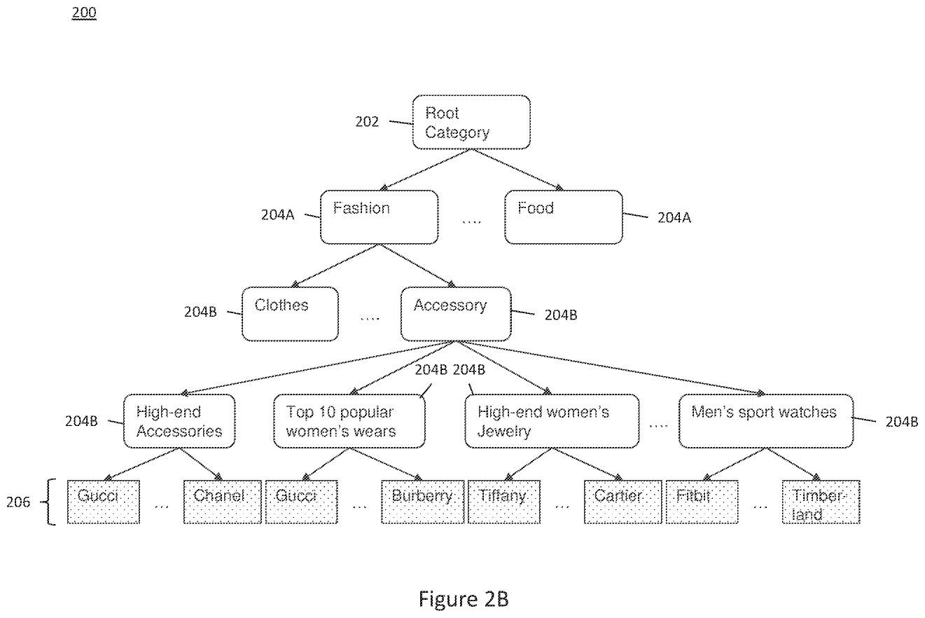

FIG. 2A is a block diagram of a tree structure 200 for storing potential advertisers 108, in accordance with some embodiments. FIG. 2B is a block diagram showing the tree structure with example data. The tree structure 200 is stored by the advertiser directory service 104 on, e.g., volatile or non-volatile computer readable storage mediums. For example, the tree structure 200 may be maintained in a relational database such as a structure query language (SQL) database, a key-value database such as a NoSQL database, or the like. A publisher 110 or supply-side platform 114 may use the tree structure 200 to quickly and accurately select matching advertisers 108 with desired performance based on criteria from the publisher 110.

The tree structure 200 is organized into a root node 202, category nodes 204, and advertiser nodes 206. The category nodes 204 include several types of categories, such as main categories 204A and sub-categories 204B. The root node 202 is the beginning of the tree structure 200, and includes multiple main categories 204A. The main categories 204A may include sub-categories 204B, advertiser nodes 206, or a combination thereof. The sub-categories 204B may themselves include further sub-categories 204B, advertiser nodes 206, or a combination thereof. The advertiser nodes 206 may be referred to as leaf nodes, and include information about the corresponding advertiser 108 so that a publisher 110 may select an advertisement.

The category nodes 204 group sets of advertiser nodes 206 with common attributes or features. During a search, one or more of the category nodes 204 are specified by search criteria. The advertiser nodes 206 beneath the specified category nodes 204 may be recommended, with any intervening sub-categories 204B being traversed. The category nodes 204 increase in specificity at greater depths of the tree structure 200, and so specifying category nodes 204 at a deeper level may result in more accurate search results, as fewer advertiser nodes 206 may match the search criteria. However, selecting category nodes 204 at a greater depth may also decrease the quantity of recommendations, as fewer advertiser nodes 206 may match the more specific criteria.

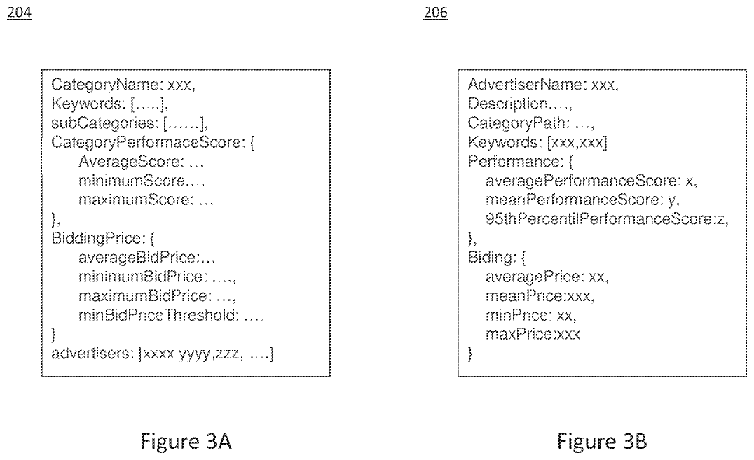

FIGS. 3A and 3B illustrate data structures that form the tree structure 200, in accordance with some embodiments. FIG. 3A is a data structure for the category nodes 204. The category nodes 204 data structure includes information such as associated subcategories, associated advertisers, performance data, and category keywords. FIG. 3B is a data structure for the advertiser nodes 206. The advertiser nodes 206 data structure includes information specific to the corresponding advertiser 108, as well as performance data and bidding information for the advertiser 108.

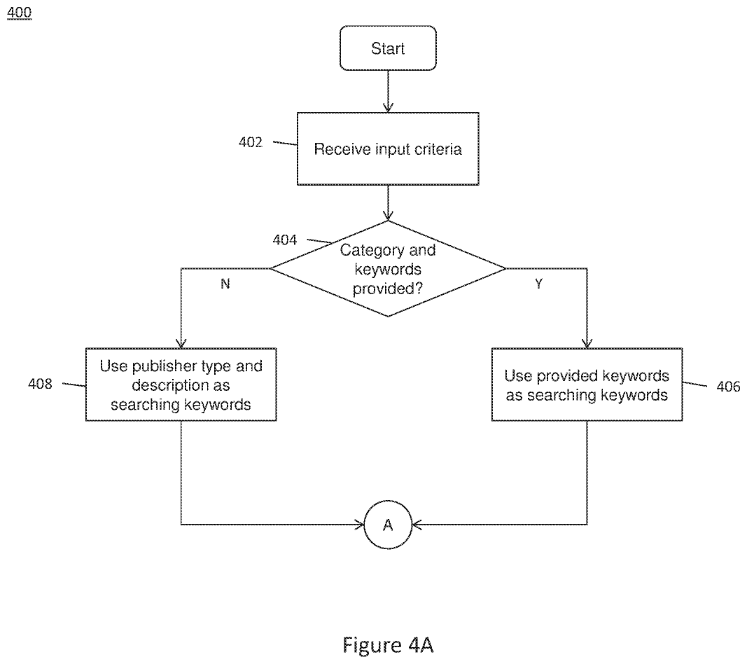

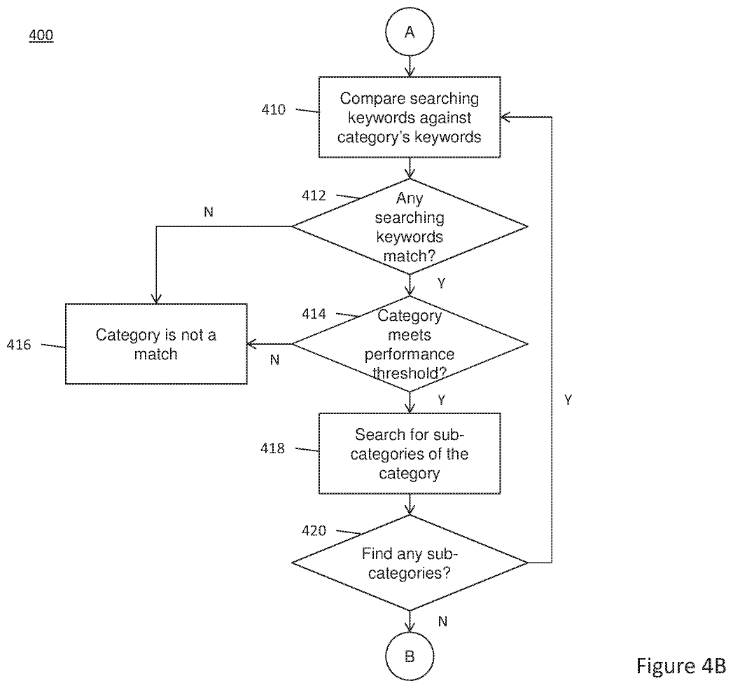

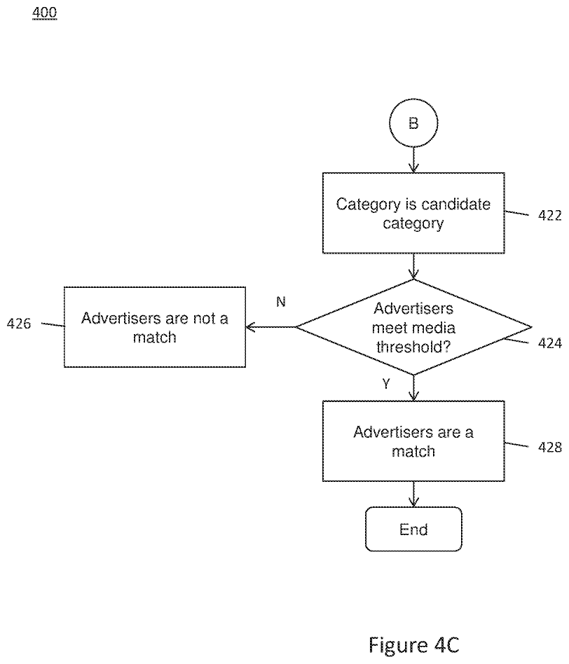

FIGS. 4A through 4C show a block diagram of a method 400 for recommending advertisers 108, in accordance with some embodiments. In particular, the method 400 is used to traverse the tree structure 200 and search for qualified and matching advertisers based on search criteria. When traversing the tree structure 200, the method 400 recursively tests category and sub-category nodes as it encounters them. Because category nodes 204 and advertiser nodes 206 increase in specificity at deeper levels, determining that a particular category node 204 is not a match allows further searching below that particular category node 204 to be avoided.

The search criteria is received (step 402). The search criteria may specify particular category nodes 204, may include key words, and may request advertisements fitting a particular media threshold (which may comprise media size and/or format). If the search criteria specifies category names and keywords (step 404), then the provided keywords are used as searching keywords when traversing the tree structure 200 (step 406). Otherwise, the type and description of the requesting publisher 110 are used as searching keywords when traversing the tree structure 200 (step 408).

The chosen searching keywords are compared to the chosen (or root) category's keywords (step 410). If the searching keywords match the category's (step 412), and if the category meets a performance score threshold specified by the search criteria (step 414), then the category is considered a match. If either condition fails, the category is considered to not be a match (step 416). If the category is a match, then the search is continued by searching for sub-categories in the matching category (step 418). If sub-categories are found (step 420), then steps 410-418 are recursively repeated for each sub-category until all nodes of the categories are tested.

The matching categories and sub-categories are considered candidate categories (step 422). For each of the candidate categories, if the advertising nodes 206 of the category nodes 204 match the desired media information specified by the search criteria (step 424), then the advertising nodes 206 are considered a match (step 428). Otherwise, the advertising nodes 206 are not considered a match and are discarded (Step 430). The matching nodes are then recommended to the requesting publisher 110, for the publisher 110 to bid on.

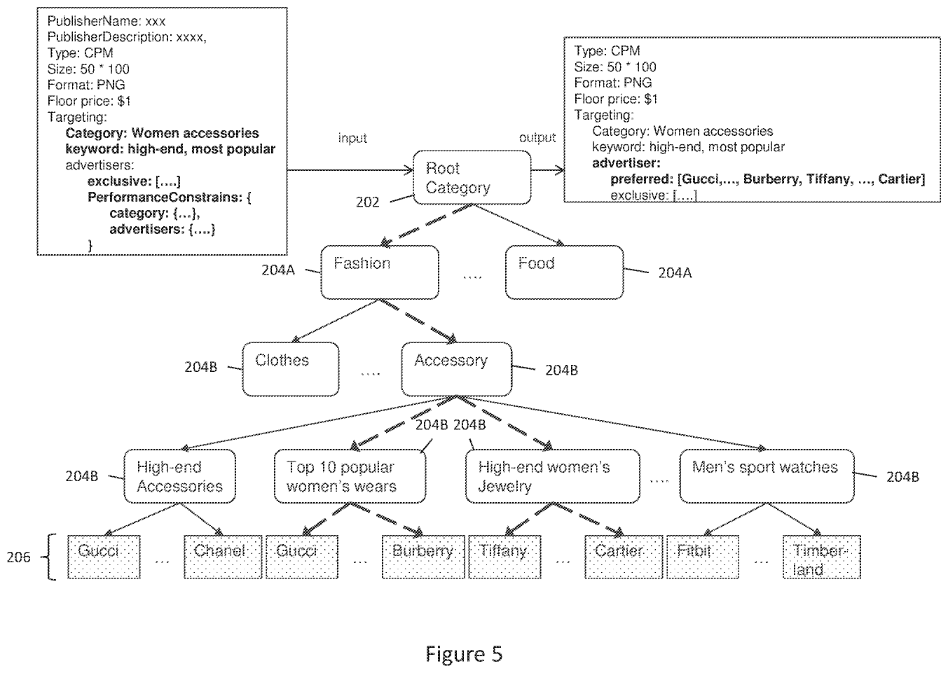

FIG. 5 illustrates traversal of the tree structure 200, in accordance with some embodiments. In the example shown, a particular category and particular keywords are provided as input parameters, along with desired performance score constraints, price constraints, and a list of excluded advertisers. The branches of the tree structure 200 matching the search criteria are shown as heavy dashed lines in FIG. 5. The output results indicate particular preferred advertisers matching the input parameters.

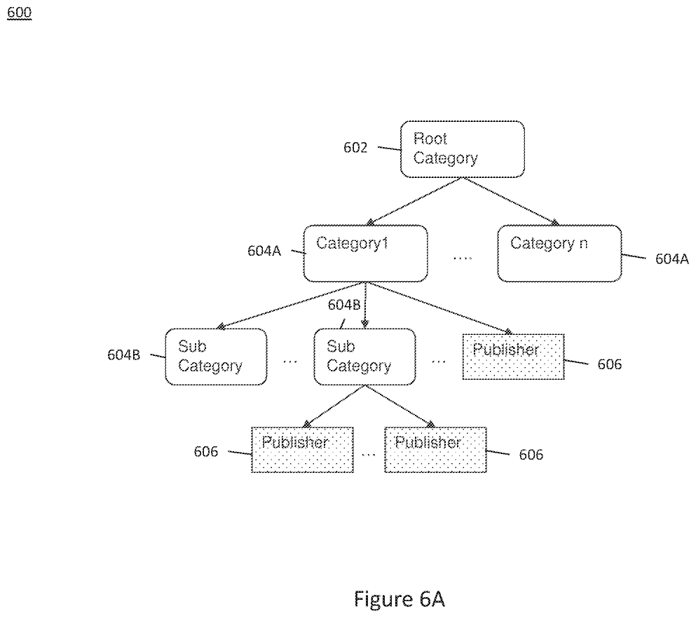

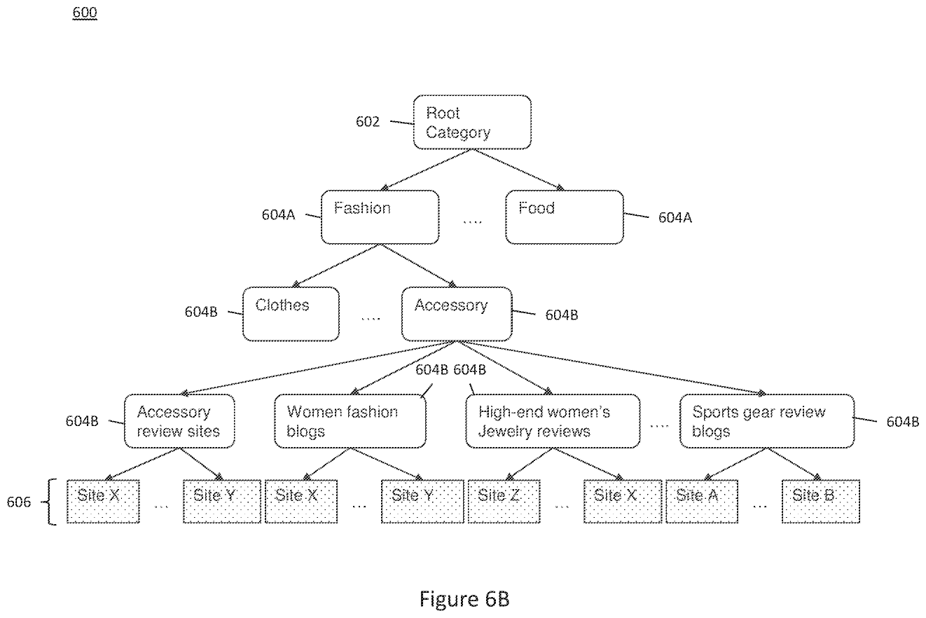

FIG. 6A is a block diagram of a tree structure 600 for storing potential publishers 110, in accordance with some embodiments. FIG. 6B is a block diagram showing the tree structure with example data. The tree structure 600 is stored by the publisher directory service 106 on, e.g., volatile or non-volatile computer readable storage mediums. For example, the tree structure 600 may be maintained in a relational database such as a SQL database, a key-value database such as a NoSQL database, or the like. An advertiser 108 or demand-side platform 112 may use the tree structure 600 to quickly and accurately select matching publishers 110 with desired performance based on criteria from the advertiser 108.

The tree structure 600 is organized into a root node 602, publisher categories 604, and publisher nodes 606. The publisher categories 604 include several types of categories, such as main categories 604A and sub-categories 604B. The root node 602 is the beginning of the tree structure 600, and includes multiple main categories 604A. The main categories 604A may include sub-categories 604B, nodes 606, or a combination thereof. The sub-categories 604B may themselves include further sub-categories 604B, nodes 606, or a combination thereof. The publisher nodes 606 may be referred to as leaf nodes, and include information about the corresponding publisher 110 so that an advertiser 108 may select a publisher.

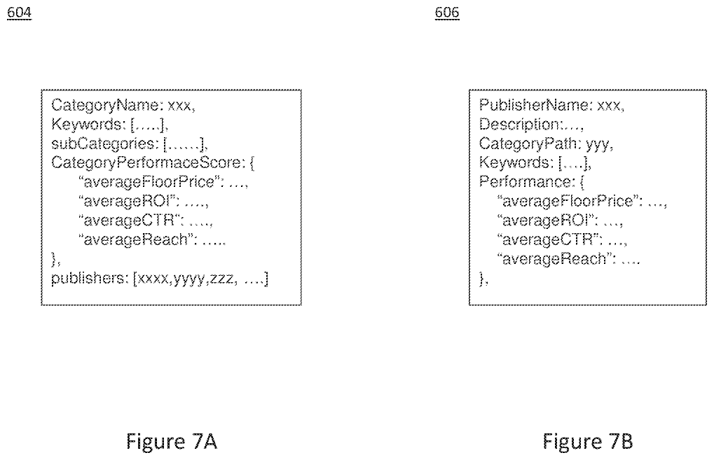

FIGS. 7A and 7B illustrate data structures that form the tree structure 600, in accordance with some embodiments. FIG. 7A is a data structure for the publisher categories 604. The publisher categories 604 data structure includes information such as associated subcategories, performance data, and category keywords. FIG. 7B is a data structure for the publisher nodes 606. The publisher nodes 606 data structure includes information specific to the corresponding publisher 110, as well as performance data information for the publisher 110.

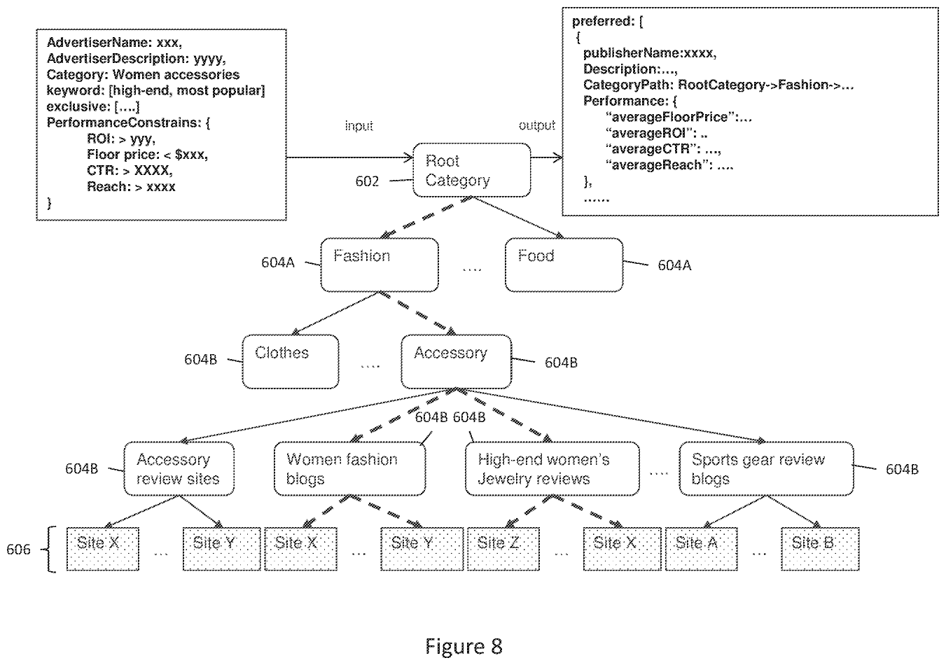

FIG. 8 illustrates traversal of the tree structure 600, in accordance with some embodiments. The tree structure 600 is similar to the tree structure 200, where deeper nodes have more specific criteria, keywords, and the like. As such, the tree structure 600 may be traversed in a similar manner as the tree structure 200, e.g., by recursively traversing the tree structure 600 using a method similar to the method 400. Details about traversal will not be repeated. In the example shown, a particular category and particular keywords are provided as input parameters, along with desired performance score constraints, price constraints, and a list of excluded advertisers. The branches of the tree structure 600 matching the search criteria are shown as heavy dashed lines in FIG. 8. The output results indicate particular preferred publishers matching the input parameters.

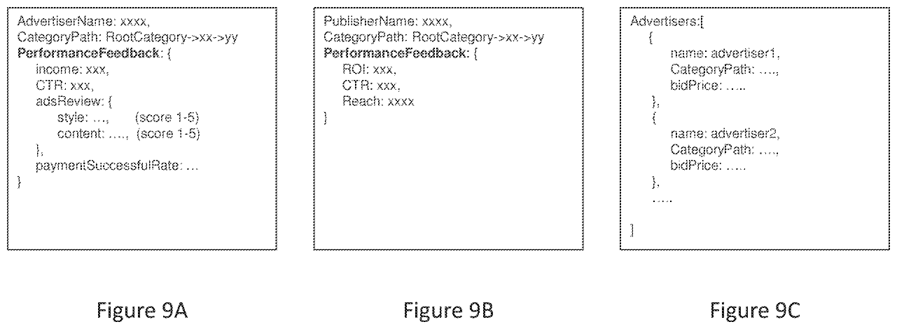

As noted above, the performance metrics of advertisers 108 and publishers 110 may be dynamically updated based on feedback from one another. FIGS. 9A, 9B, and 9C illustrate data structures that may be used to communicate performance feedback about the advertisers 108 and publishers 110, in accordance with some embodiments. FIG. 9A shows a data structure for performance feedback for an advertiser 108. FIG. 9B shows a data structure for performance feedback for a publisher 110. FIG. 9C shows a data structure for performance feedback about bid prices for advertisers 108 from a demand-side platform 112.

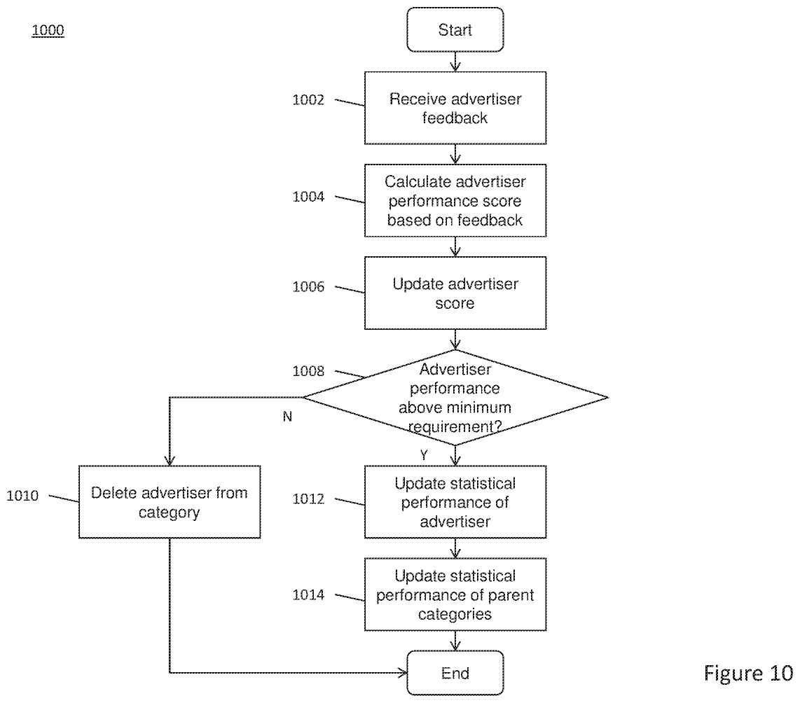

FIG. 10 shows a block diagram of a method 1000 for updating performance of advertisers 108, in accordance with some embodiments. The method 1000 is used to update a tree structure based on received performance feedback. In the example shown, the method 1000 is performed by the advertiser directory service 104 to update the tree structure 200 in response to receiving advertiser or bid price feedback. It should be appreciated that a similar method may be performed by the publisher directory service 106 to update the tree structure 600 in response to receiving platform feedback.

The feedback for an advertiser 108 is received (step 1002). The feedback is received from one or more publishers 110, and may be similar to the data structure shown in FIG. 9A. As shown, the feedback includes scores such as ratings of an advertiser's style, content, and the like. The feedback is used to calculate a performance score for the advertiser 108 (step 1004). The performance score may be a number that is calculated according to the feedback data. The performance score is stored in the tree structure 200 (step 1006).

If the performance score for the advertiser 108 fall below minimum scoring requirements (step 1008), then the advertiser 108 is deleted from its corresponding category (step 1010). For example, if the performance score is below a predetermined threshold, the advertiser 108 is removed. Conversely, if the advertiser's performance score is above a minimum threshold, then the method 1000 proceeds.

Statistical performance information for the advertiser 108 is then calculated and updated in the advertiser node 206 for the advertiser 108 (step 1012). For example, the performance score may be used to update running values such as the average performance score, the mean performance score, the 95^{th} percentile performance score, and the like (see FIG. 3B) for the advertiser 108. The averages may be a weight or unweighted average. Bidding price information of the advertiser 108 may be updated when the received feedback is bid price feedback. Statistical performance information for the parent categories of the advertiser 108 are then calculated and updated in the category nodes 204 for the advertiser 108 (step 1014). In particular, the statistical performance information of the advertiser 108 may be used to update running values such as the average, minimum, and maximum scores (see FIG. 3A) for each category branch of the tree structure 200 that the advertiser 108 is in. The averages may be a weight or unweighted average. Referring to the example shown in FIG. 5, when the statistical performance information for the “Cartier” advertiser 108 is updated, then the statistical performance information for the “High-end women's Jewelry, “Accessory,” and “Fashion” category nodes 204 are also updated.

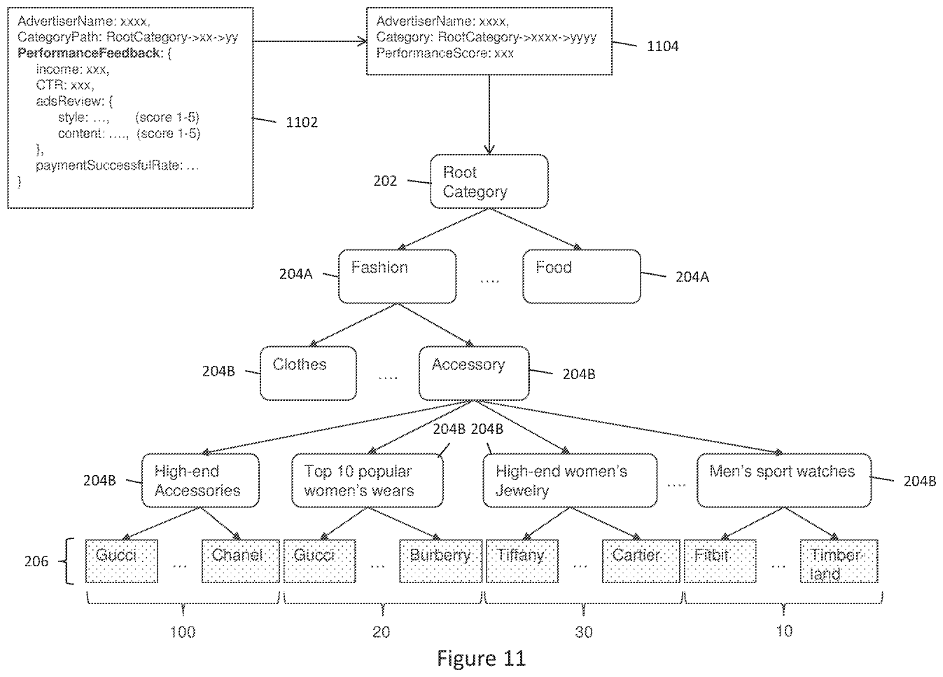

In some embodiments, the statistical performance information for an category nodes 204 includes a weighted average of the advertiser nodes 206 in that category. Each advertiser 108 may have a weight, with the scores and the weight for each advertiser being used to determine the scores for the advertiser's parent category node 204. FIG. 11 shows such an example. In the example of FIG. 11, advertiser feedback 1102 is used to determine an advertiser performance score 1104. The advertiser performance score 1104 may be determined by taking a weighted average of the values in the “PerformanceFeedback” field of the advertiser feedback 1102. The advertiser performance score 1104 may then be used to update statistical performance information for the category nodes 204 and the advertiser node 206 corresponding to the advertiser feedback 1102.

In some embodiments, the advertiser weights are configured for each publisher 110. For example, a first publisher 110 may assign a first set of weights to the advertisers 108, and a second publisher 110 may assign a second set of weights to the advertisers 108. The category scores are thus computed for each publisher 110.

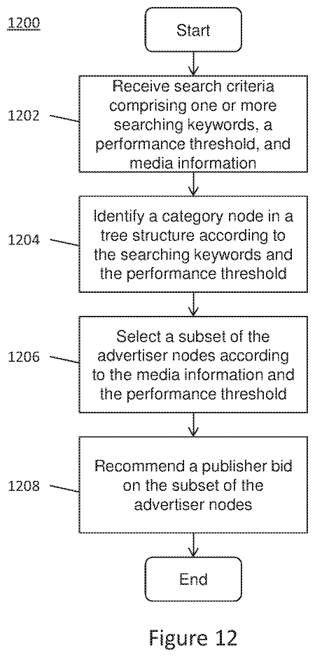

FIG. 12 illustrates an advertiser recommendation method 1200, in accordance with some embodiments. The advertiser recommendation method 1200 may be performed by components of the system 100 when recommending advertisements to a publisher. In step 1202, search criteria is received. The search criteria comprises one or more searching keywords, a performance threshold, and media information. In step 1204, a category node in a tree structure is identified according to the searching keywords and the performance threshold. The category node includes a plurality of advertiser nodes. In step 1206, a subset of the advertiser nodes is selected according to the media information and the performance threshold. In step 1208, a publisher is recommended to bid on the subset of the advertiser nodes.

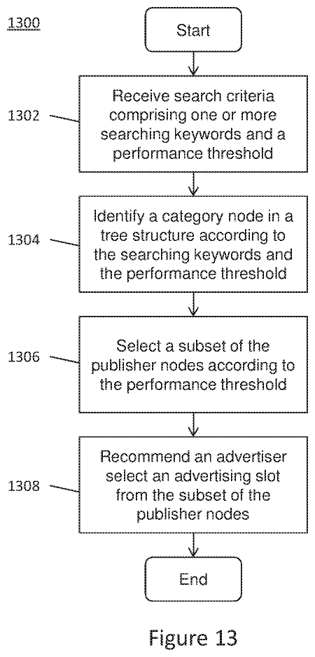

FIG. 13 illustrates a publisher recommendation method 1300, in accordance with some embodiments. The publisher recommendation method 1300 may be performed by components of the system 100 when recommending publishers to an advertiser. In step 1302, search criteria is received. The search criteria comprises one or more searching keywords and a performance threshold. In step 1304, a category node in a tree structure is identified according to the searching keywords and the performance threshold. The category node comprises a plurality of publisher nodes. In step 1306, a subset of the publisher nodes are selected according to the performance threshold. In step 1308, an advertiser is recommended to select an advertising slot from the subset of the publisher nodes.

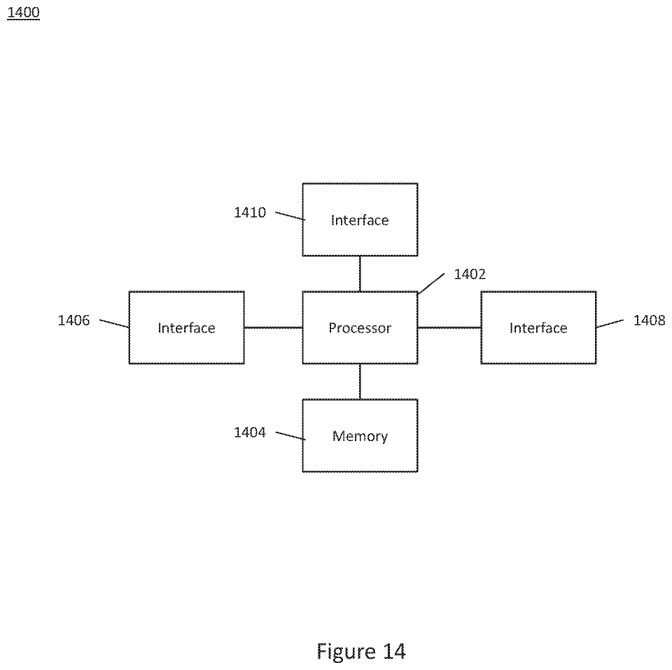

FIG. 14 is a block diagram of a processing system 1400 for performing methods described herein, which may be installed in a host device. As shown, the processing system 1400 includes a processor 1402, a memory 1404, and interfaces 1406-1410, which may (or may not) be arranged as shown in FIG. 14. The processor 1402 may be any component or collection of components adapted to perform computations and/or other processing related tasks, and the memory 1404 may be any component or collection of components adapted to store programming and/or instructions for execution by the processor 1402. In an embodiment, the memory 1404 includes a non-transitory computer readable medium. The interfaces 1406, 1408, 1410 may be any component or collection of components that allow the processing system 1400 to communicate with other devices/components and/or a user. For example, one or more of the interfaces 1406, 1408, 1410 may be adapted to communicate data, control, or management messages from the processor 1402 to applications installed on the host device and/or a remote device. As another example, one or more of the interfaces 1406, 1408, 1410 may be adapted to allow a user or user device (e.g., personal computer (PC), etc.) to interact/communicate with the processing system 1400. The processing system 1400 may include additional components not depicted in FIG. 14, such as long term storage (e.g., non-volatile memory, etc.).

In some embodiments, the processing system 1400 is included in a network device that is accessing, or part otherwise of, a telecommunications network. In one example, the processing system 1400 is in a network-side device in a wireless or wireline telecommunications network, such as a base station, a relay station, a scheduler, a controller, a gateway, a router, an applications server, or any other device in the telecommunications network. In other embodiments, the processing system 1400 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a receiving unit/module, an identifying unit/module, a selecting unit/module, a recommending unit/module, and/or an updating unit/module. The respective units/modules may be hardware, software, or a combination thereof. For instance, one or more of the units/modules may be an integrated circuit, such as field programmable gate arrays (FPGAs) or application-specific integrated circuits (ASICs).

Embodiments may achieve advantages. Use of embodiment techniques may allow advertisers 108 and publishers 110 to be quickly and accurately matched with one another. By storing scores and information in the tree structures 200 and 600, a database used for storing advertiser and/or publisher information may be improved. In particular, matches may be performed using the category nodes of the tree structure, so that each leaf node may not need to be individually evaluated.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage. A computer program may be stored or distributed on a suitable medium, such as an optical storage medium or a solid-state medium supplied together with, or as part of, other hardware, but may also be distributed in other forms, such as via the Internet or other wired or wireless telecommunication systems.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A computer-implemented method comprising:
receiving, with one or more processors, search criteria for searching one or more advertisers that are configured to provide advertisements, the search criteria comprising one or more searching keywords, a performance threshold, and media information;
identifying, with the one or more processors, a category node in a tree structure according to the one or more searching keywords and the performance threshold, the tree structure comprising a plurality of category nodes corresponding to different categories of advertisers, the category node comprising a plurality of advertiser nodes, and the plurality of advertiser nodes representing a first set of advertisers of a first category corresponding to the category node, wherein the first set of advertisers matches the one or more searching keywords and the performance threshold;
selecting, with the one or more processors, a first advertiser node from the plurality of advertiser nodes that matches the media information and the performance threshold, the first advertiser node representing a first advertiser; and
indicating, with the one or more processors, the first advertiser to a publisher, recommending the publisher to bid for displaying an advertisement of the first advertiser by the publisher.

2. The method of claim 1, wherein the category node comprises a plurality of sub-category nodes, each of which represents a sub-category of the first category, and wherein the plurality of sub-category nodes comprise the plurality of advertiser nodes.

3. The method of claim 2, further comprising:
selecting, with the one or more processors, a subset of the plurality of sub-category nodes according to the performance threshold, wherein the first advertiser node is comprised in the subset.

4. The method of claim 1, wherein the category node comprises a performance score associated with the category node, and wherein identifying the category node comprises:
selecting the category node in response to the performance score of the category node being greater than the performance threshold of the search criteria.

5. The method of claim 1, wherein the first advertiser node comprises media information and a performance score associated with the first advertiser node, and wherein selecting the first advertiser node from the plurality of advertiser nodes comprises:
selecting, with the one or more processors, the first advertiser node in response to the media information of the first advertiser node matching the media information of the search criteria, and in response to the performance score associated with the first advertiser node being greater than the performance threshold of the search criteria.

6. The method of claim 5, further comprising:
receiving, with the one or more processors, advertiser feedback of an advertiser corresponding to an advertiser node of the plurality of advertiser nodes; and
updating, with the one or more processors, a performance score of the advertiser node according to the advertiser feedback.

7. The method of claim 5, further comprising:
receiving bid price feedback about a bid price of an advertiser; and
updating bidding price information of an advertiser node of the plurality of advertiser nodes according to the bid price feedback, the advertiser node corresponding to the advertiser.

8. The method of claim 1, wherein the one or more searching keywords comprise a category name.

9. A computer-implemented method comprising:
receiving, with one or more processors, search criteria for searching one or more publishers that are configured to display advertisements on a media platform, the search criteria comprising one or more searching keywords and a performance threshold;
identifying, with the one or more processors, a category node in a tree structure according to the one or more searching keywords and the performance threshold, the tree structure comprising a plurality of category nodes corresponding to different categories of publishers, the category node comprising a plurality of publisher nodes, and the plurality of publisher nodes representing a first set of publishers of a first category corresponding to the category node, wherein the first set of publisher matches the one or more searching keywords and the performance threshold;
selecting, with the one or more processors, a first publisher node from the plurality of publisher nodes that matches the performance threshold of the search criteria, the first publisher node representing a first publisher; and
indicating, with the one or more processors, the first publisher to an advertiser, recommending the advertiser to select an advertising slot of the first publisher for advertisement.

10. The method of claim 9, wherein the category node comprises a plurality of sub-category nodes, each of which represents a sub-category of the first category, and wherein the plurality of sub-category nodes comprise the plurality of publisher nodes.

11. The method of claim 10, further comprising:
selecting, with the one or more processors, a subset of the plurality of sub-category nodes according to the performance threshold, wherein the first publisher node is comprised in the subset.

12. The method of claim 9, wherein the category node comprises a performance score associated with the category node, and wherein identifying the category node comprises:
selecting the category node in response to the performance score of the category node being greater than the performance threshold of the search criteria.

13. The method of claim 9, wherein the first publisher node comprises a performance score associated with the first publisher node, and wherein selecting the first publisher node comprises:
selecting, with the one or more processors, the first publisher node in response to the performance score of the first publisher node being greater than the performance threshold of the search criteria.

14. The method of claim 13, further comprising:
receiving, with the one or more processors, publisher feedback of a publisher; and
updating, with the one or more processors, a performance score of a publisher node of the plurality of publisher nodes according to the publisher feedback, the publisher node corresponding to the publisher.

15. The method of claim 9, wherein the one or more searching keywords comprise a category name.

16. A device comprising:
a non-transitory memory storage comprising instructions; and
one or more processors in communication with the memory storage, wherein the one or more processors execute the instructions to cause the device to:
receive search criteria for searching one or more advertisers that are configured to provide advertisements, the search criteria comprising one or more searching keywords, a performance threshold, and media information;
identify a category node in a tree structure according to the one or more searching keywords and the performance threshold, the tree structure comprising a plurality of category nodes corresponding to different categories of advertisers, the category node comprising a plurality of advertiser nodes, and the plurality of advertiser nodes representing a first set of advertisers of a first category corresponding to the category node, wherein the first set of advertisers matches the one or more searching keywords and the performance threshold;
select a first advertiser node from the plurality of advertiser nodes that matches the media information and the performance threshold, the first advertiser node representing a first advertiser; and
indicate the first advertiser to a publisher, recommending the publisher to bid for displaying an advertisement of the first advertiser by the publisher.

17. The device of claim 16, wherein the category node comprises a performance score associated with the category node, and wherein identifying the category node comprises:
selecting the category node in response to the performance score of the category node being greater than the performance threshold of the search criteria.

18. The device of claim 16, wherein the one or more processors execute the instructions to cause the device further to:
receive advertiser feedback of an advertiser; and
update a performance score of an advertiser node of the plurality of advertiser nodes according to the advertiser feedback, the advertiser node corresponding to the advertiser.

19. A device comprising:
a non-transitory memory storage comprising instructions; and
one or more processors in communication with the memory storage, wherein the one or more processors execute the instructions to cause the device to:
receive search criteria for searching one or more publishers that are configured to display advertisements on a media platform, the search criteria comprising one or more searching keywords and a performance threshold;
identify a category node in a tree structure according to the one or more searching keywords and the performance threshold, the tree structure comprising a plurality of category nodes corresponding to different categories of publishers, the category node comprising a plurality of publisher nodes, and the plurality of publisher nodes representing a first set of publishers of a first category corresponding to the category node, wherein the first set of publisher matches the one or more searching keywords and the performance threshold;
select a first publisher node from the plurality of publisher nodes that matches the performance threshold of the search criteria, the first publisher node representing a first publisher; and
indicate the first publisher to an advertiser, recommending the advertiser to select an advertising slot of the first publisher for advertisement.

20. The device of claim 19, wherein the category node comprises a performance score associated with the category node, and wherein identifying the category node comprises:
selecting the category node in response to the performance score of the category node being greater than the performance threshold of the search criteria.
